(19) United States
(12) Patent Application Publication
(10) Pub. No.: US 2005/0259801 A1
(43) Pub. Date: Nov. 24, 2005

(54) Machine and process for accepting customer payments and placing orders

(76) Inventors: Charles Craig Bullard, Aledo, TX (US); David DuWayne Wise, Bedford, TX (US)

Correspondence Address: CASH KLEMCHUK POWERS TAYLOR LLP, CAMPBELL CENTRE II, 8150 NORTH CENTRAL EXPRESSWAY, SUITE 1575, DALLAS, TX, 75206, US

(21) Appl. No.: 11/017,504

(22) Filed: Dec. 20, 2004

Related U.S. Application Data
(60) Provisional application No. 60/572,555, filed on May 19, 2004.

(51) Int. Cl. H04M 11/00; H04M 15/00

(52) U.S. Cl. 379/144.01; 379/114.01; 379/93.01

(57) ABSTRACT

A machine and process for accepting customer payments and placing orders for telecommunications services is disclosed. The machine and process include a kiosk operable to accept account set-up information from an individual, accept payment from the individual, collect identifying data from the individual, and communicate with a system to activate a telecommunication account for the individual. The kiosk may be placed wherever quick telecommunication account set-up and payment verification is necessary, for example: a correctional facility or college campus.

### PRIORITY CLAIM

This application claims priority to U.S. Provisional Patent Application No. 60/572,555, filed on May 19, 2204, by the inventors and of the same title, which is hereby incorporated by reference.

### BACKGROUND

1. Field of the Invention

This invention relates generally to the field of telecommunications and more specifically it relates to a machine and process for rapidly accepting customer payments and placing orders for telecommunication services.

2. Description of Related Art

Since the inception of facility based call processing in correctional facilities, telecommunication providers have struggled with a variety of issues including new account set-up, collection of monies, and posting of payments in a timely manner. New account set-up for inmates and friends or family that desire to engage in telephone conversations with an inmate may take as long as two to three business days. Once the account is set-up then the issue of payment method must be resolved. Currently telecommunications providers will accept payment by check or money order via the US Postal Service; by credit card, debit card, or direct funds transfer from an existing checking account via an Interactive Voice Response System accessed by telephone; or by Western Union.

Because customers expect fast and efficient service, the above described system tends to create customer service calls that cost the telecommunication provider. Therefore, it would be preferred to have a system that could establish new accounts rapidly and reduce customer service calls relating to account set-up delays.

Customers also expect to be able to use cash for most transactions without a penalty. The current system requires a money order and the delay of mailing to hinder the use of cash in the telecommunication service transaction. Therefore, it would be preferred to have a system that allowed easy cash payment to set-up and maintain telecommunication service for an inmate by the inmate at booking, by the inmate during incarceration, and by friends or family who are not incarcerated.

As an attempt to address some of the delays in set-up, telecommunications providers have incurred high levels of bad debt. Bad debt is expensive to incur because of the administrative overhead involved in carrying and managing the debt as well as the direct write-offs. It would be preferred to have a system that quickly verified payments to reduce bad debt while also providing quick set-up and reduced calls to customer service.

A final problem facing the current system of providing telecommunications services in correctional institutions is that of the short stay inmate, for example an inmate who may stay in lockup for less than 3 days while arranging bail. The time lag for set-up for these inmates is longer than their anticipated stay, so the telecommunication provider has no opportunity to effectively serve these potential clients. This is lost business for the telecommunication provider and an aggravation for the inmate who is unable to communicate effectively with friends or family.

Although the problems listed above are specific to the correctional facilities market, similar problems are found in other situations where the invention may be helpful. Therefore, the invention described below is not to be limited to correctional facilities, nor is the invention to be limited to solving the problems listed above.

### SUMMARY

There is a need in correctional facilities and other markets for a machine and process for accepting customer payments and placing orders relating to telecommunications services.

Therefore, it is an object of the present invention to provide a machine and process for accepting customer payments and placing orders relating to telecommunications services.

This object may be achieved by providing a kiosk operable to accept account set-up information from an individual, accept payment from the individual, collect identifying data from the individual, and communicate with a system to activate a telecommunication account for the individual. The kiosk may be placed wherever quick telecommunication account set-up and payment verification is necessary, for example: a correctional facility or a college campus.

The present invention provides significant advantages, including: (1) set-up information may be collected in a variety of written languages without the need for extensive translation services; (2) payment may be verified at the point of sale thereby avoiding bad debts; (3) identifying data may be stored with a transaction record to facilitate matching the transaction to a particular person; (4) account activation may be automated and provided at the time of transaction; and (5) costs per account may be reduced by reducing costs associated with account set-up inquiries and associated customer service calls.

Additional objectives, features, and advantages of the invention will be apparent in the written description that follows.

### BRIEF DESCRIPTION OF THE DRAWINGS

The novel features believed characteristic of the invention are set forth in the appended claims. However, the invention itself, as well as, a preferred mode of use, and further objectives and advantages thereof, will best be understood by reference to the following detailed description when read in conjunction with the accompanying drawings, wherein:

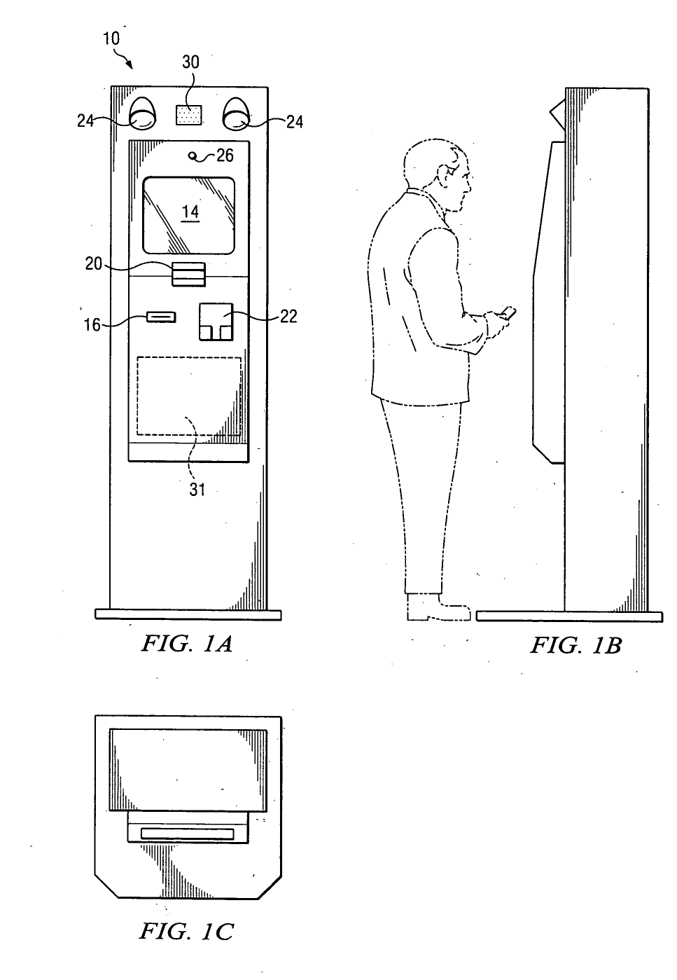

1. FIG. 1A is a front view of a kiosk;

2. FIG. 1B is a side view of the kiosk of FIG. 1A

3. FIG. 1C is a top view of the kiosk of FIG. 1A;

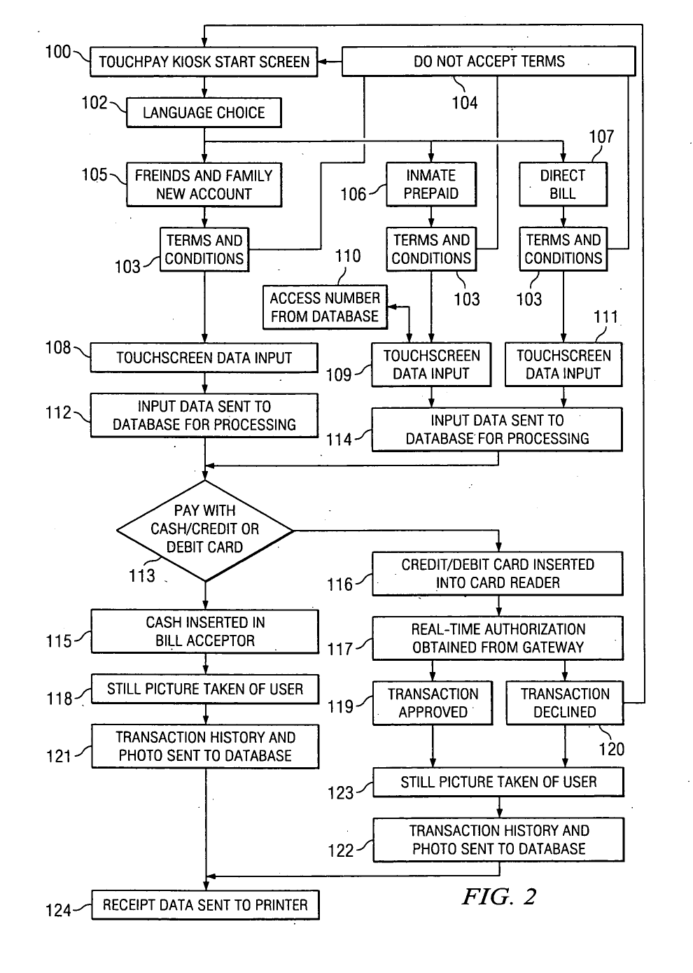

4. FIG. 2 is a flow chart of an operation of a kiosk;

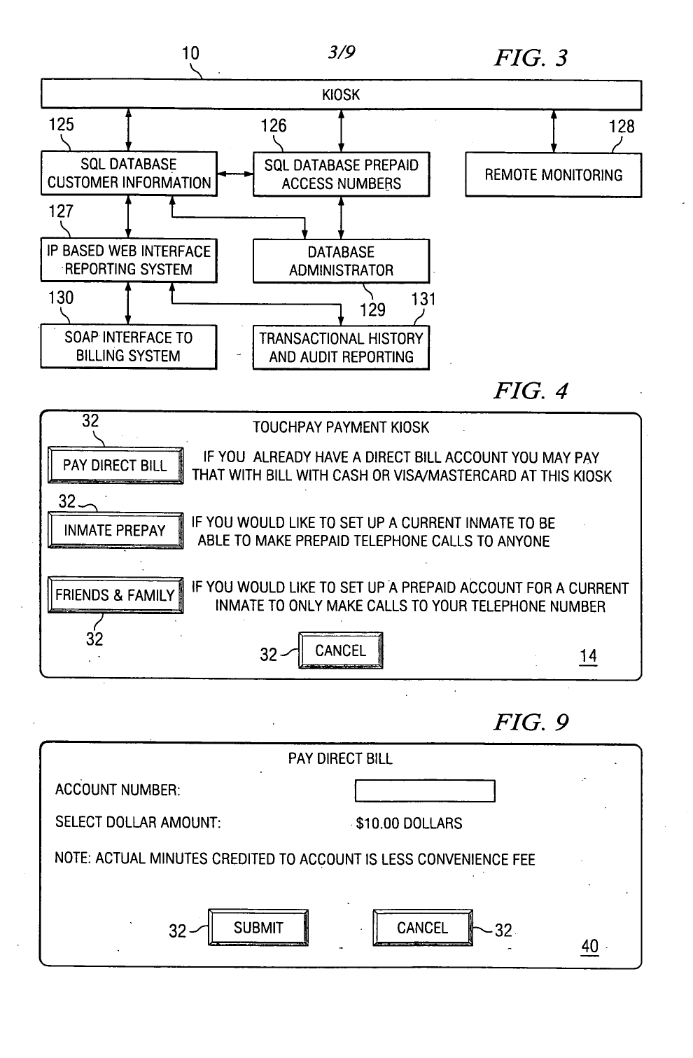

5. FIG. 3 is a schematic of a system including the kiosk of FIG. 2;

6. FIG. 4 is an example of a menu screen that may be presented at a kiosk;

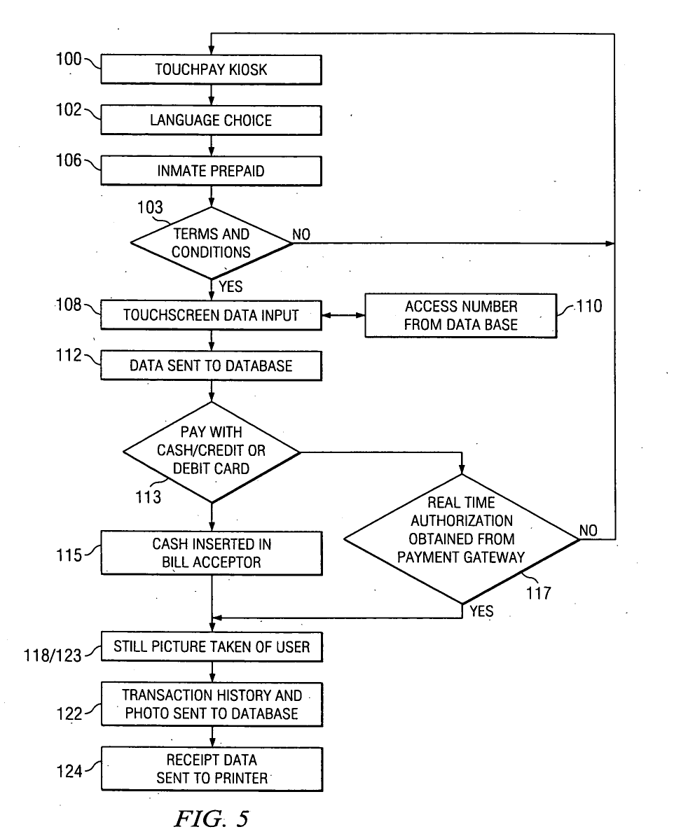

7. FIG. 5 is a flow chart of an Inmate Prepaid Account transaction;

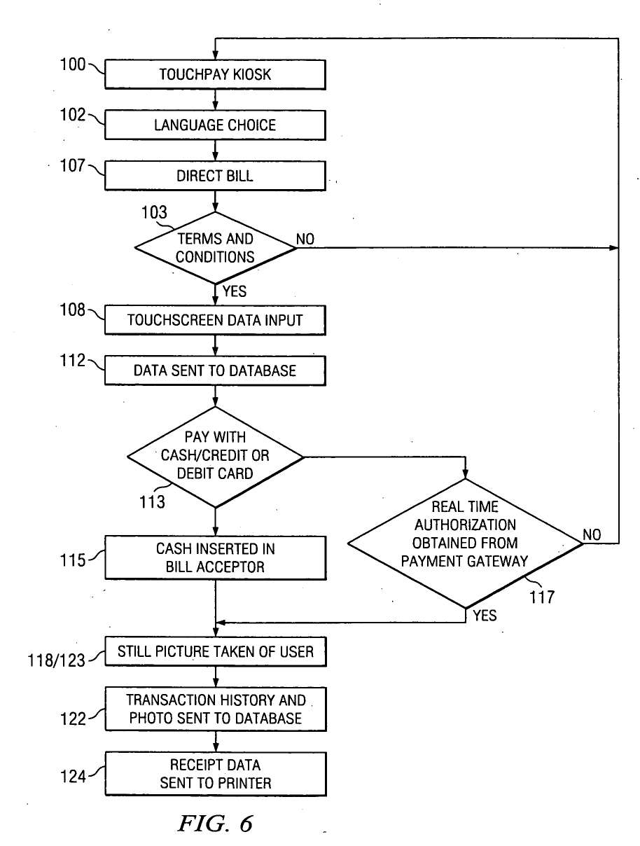

8. FIG. 6 is a flow chart of a Direct Bill transaction;

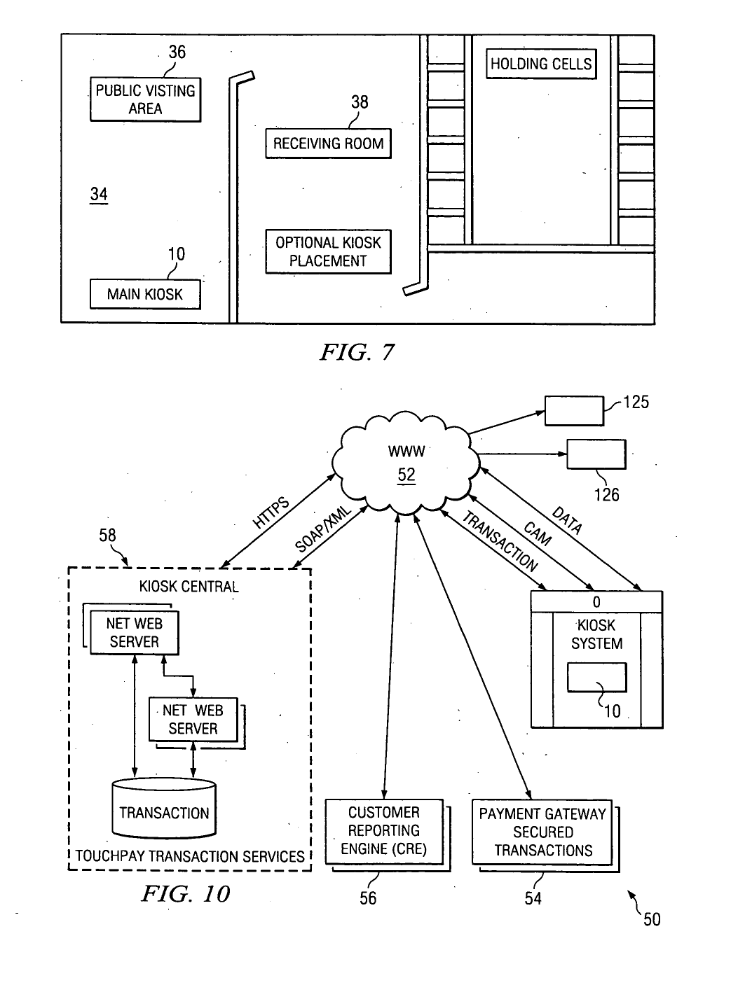

9. FIG. 7 is a schematic of possible kiosk locations within a correctional facility;

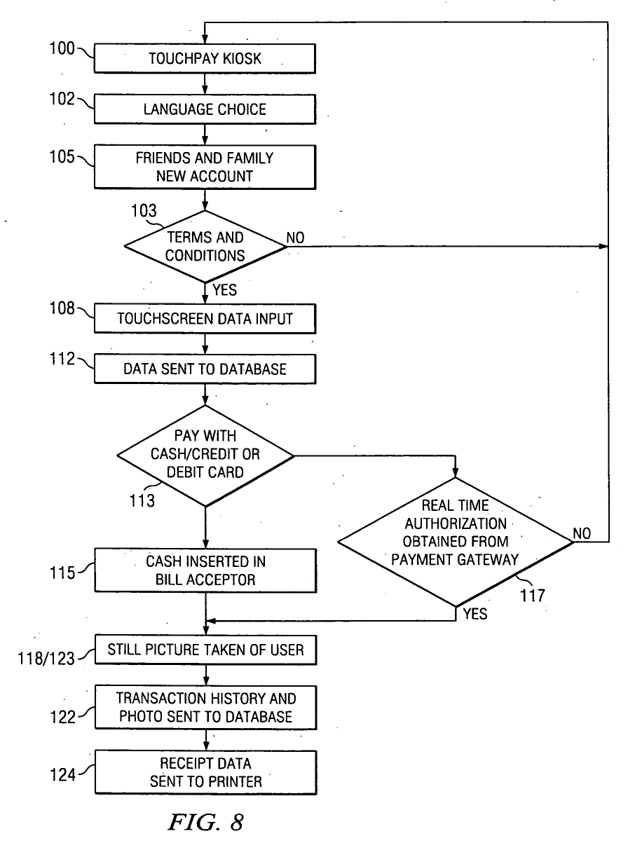

10. FIG. 8 is a flow chart of a Friends and Family transaction;

11. FIG. 9 is an example of a Graphical Customer Interface with a touch sensitive keyboard;

12. FIG. 10 is a schematic of a system associated with a kiosk for processing account transactions;

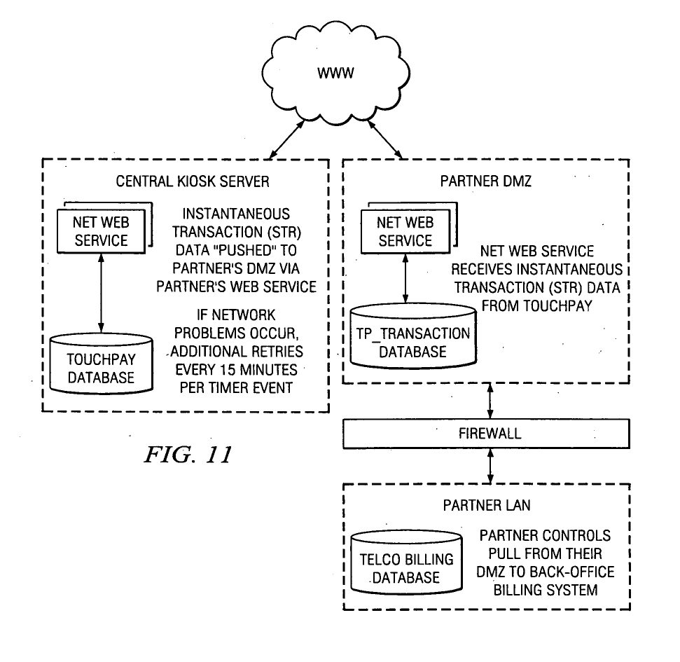

13. FIG. 11 is a schematic of a system associated with a kiosk for processing account transactions; and

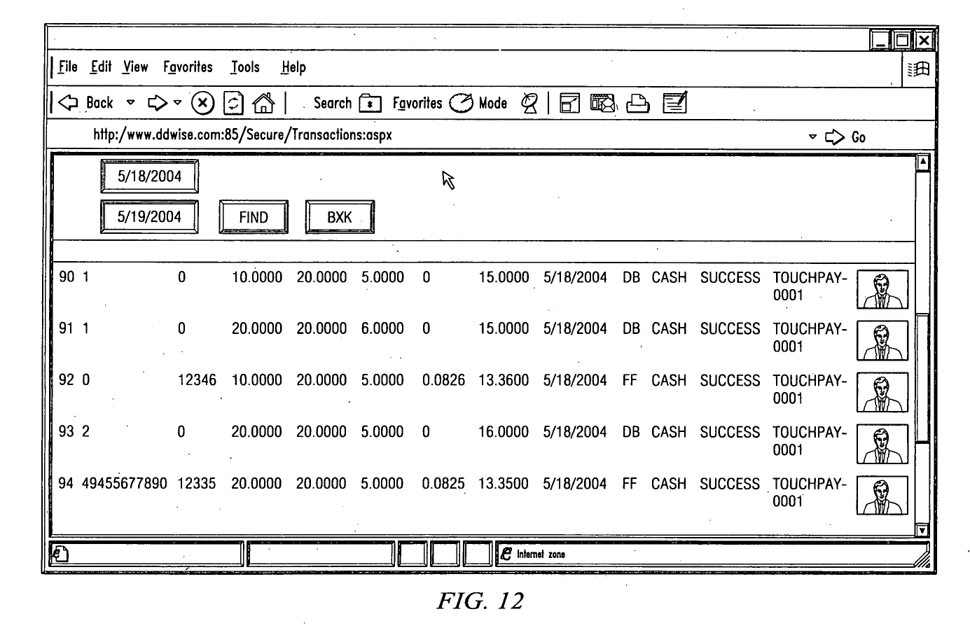

14. FIG. 12 is an example of a Graphical User Interface for a Customer Report Engine.

### DESCRIPTION OF THE PREFERRED EMBODIMENT

In the following detailed description of the preferred embodiments, reference is made to the accompanying drawings, which form a part hereof, and in which is shown by way of illustration specific preferred embodiments in which the invention may be practiced. These embodiments are described in sufficient detail to enable those skilled in the art to practice the invention, and it is understood that other embodiments may be utilized and that logical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

The present invention represents the discovery that a properly equipped kiosk may communicate with a properly equipped system to provide telecommunication service account set-up and payment autonomously with reduced customer service costs and reduced bad debt. The system according to the present invention is particularly useful in applications where delays may cause additional customer service calls or reduce the number of available customers, as well as applications where bad debt is expected to be high.

Referring to FIGS. 1A and 1B in the drawings, a kiosk 10 is shown as an interface to be used by customers (shown in dashed lines) to conduct transactions relating to telecommunication services. Kiosk 10 has input/output devices 12 to communicate during a transaction. In a preferred embodiment, a touchscreen 14 provides for simultaneous input and output by allowing a customer to make selections in a menu driven environment. A printer 16 may also be used as an output device to provide a physical receipt of the transaction for a customer. Additionally, kiosk 10 has payment readers 18 to read various methods of payment. In a preferred embodiment payment readers 18 include a magnetic card reader 20 for reading credit cards, debit cards and other magnetic payment cards, as well as a bill validator 22 that reads and validates paper money. As new payment methods become commonplace, such as Radio Frequency Identification (RFID), barcodes, or wireless technologies, the appropriate payment readers 18 may be added to kiosk 10.

Continuing with FIGS. 1A and 1B of the drawings, kiosk 10 may include speakers 24 to provide audio output such as response feedback or oral instructions for customers with limited reading skills. Kiosk 10 preferably also includes identification recording devices 26 to provide a record of the individual who was the customer for a particular transaction. Although preferred, the invention does not require the measurement and recording of biometric data. However, one skilled in the art will appreciate the advantages of taking such measurements. Recording devices 26 will record a biometric measurement of the customer for storage with the transaction record. In the preferred embodiment, a unidirectional cardoid microphone 28 is used to provide a voice recording, or voice print, and a camera 30 is used to record a still photograph of the customer's face, or face scan. Additionally, other biometric measurement devices may be used depending on the level of security desired and future developments in the security technologies field. Some other biometric measurements that may be used include fingerprints, cornea scans, and hand prints. Each technology has its own advantages and disadvantages depending on the end use.

The physical housing of the preferred embodiment of kiosk 10 shown in FIGS. 1A and 1B is optimized to reduce footprint while still providing adequate user interaction and security. Kiosk 10 may also be built into a wall with public access on one side 20 of the wall and restricted access on the opposite side of the wall. Additionally, kiosk 10 may provide additional input/output devices for the handicapped, such as a lower touchscreen 14 for wheelchair access, volume controls for the hearing impaired, or a braille display for the blind. Furthermore, the kiosk is powered by a processor 31 that directs the above listed features and collects data. Processor 31 may be a standard personal computer, which provides ease of repair and cost savings. Processor 31 is also adapted to communicate with a communications network, as will be described in more detail below.

Referring now to FIG. 2 of the drawings, an operation of kiosk 10 is shown as a flow chart. “Touchpay Kiosk Start Screen” 100 allows the customer to indicate when the customer is prepared to begin a transaction. “Language choice” 102 allows the customer to choose a preferred language in which to communicate with kiosk 10. Because the system is menu driven and field based, the number of languages that may be chosen is limited only by the initial translation costs for each language and the availability of appropriate fonts to display each language. Once a language is chosen at “language choice” 102, the remainder of the transaction is conducted in the chosen language until the user returns to “start screen” 100. After choosing the appropriate language, the customer is presented with at least three choices, as shown in FIG. 4. The choices shown are: “Friends and Family New Account” 105; “Inmate Prepaid” 106; and “Direct Bill” 107. These three basic transactions operate slightly differently, but have significant parallels. Upon, selecting any of these three choices, the customer is presented with “Terms and conditions” 103, which allows the customer to agree with certain terms and conditions for the use of kiosk 10 and the related system or to disagree. Agreement is required to proceed and failure to agree leads to “do not accept terms” 104 followed by “start screen” 100. One skilled in the art would recognize that additional choices and services can be provided, including but not limited to commissary payments, traffic citations, property tax citations, and the like.

After selecting the appropriate transaction, a “touchscreen data input” 108, 109, 111 requires the entry of all pertinent information to setup the appropriate account. After entry of “touchscreen data input” 109 for an inmate prepaid transaction an “access number obtained from database” 110 obtains an active access number for the customer from a database of prepaid access numbers 126 (shown in FIG. 3). “Input data sent to database for processing” 112, 114 indicates that all data input by the customer at “touchscreen data input” 108, 109, 111 is sent to a database of customer information 125 (shown in FIG. 3) for processing while payment information is gathered. The customer then must choose an appropriate payment method at “pay with cash/credit or debit card” 113. If cash payment is selected, the cash is fed into bill validator 22 as shown at “cash inserted in bill acceptor” 115. If credit card or debit card payment is chosen, the appropriate card is fed into magnetic card reader 20 as indicated by “credit/debit card inserted into card reader” 116, the card reader 20 then transmits the data to a gateway for real-time authorization or denial as indicated at “real-time authorization obtained from gateway” 117, and proceed to “transaction approved” 119 or “transaction declined” 120. This provides for real time set up and authorization of an account or at least substantially contemporaneous with the transaction.

At this point, whether the bills are validated or not, whether card payment is accepted or not, the transactions all record relevant transaction data for review. Biometric data is gathered at “still picture taken of user” 118, 123 and the biometric data is sent with the complete details of the transaction to a database at “transaction history and photo sent to database” 121, 122. Certain data is then printed for the customer to retain a physical receipt at “receipt data sent to printer” 124.

Referring now to FIG. 3 of the drawings, kiosk 10 is shown schematically in relation to the system for providing account setup and management. Kiosk 10 communicates with database of prepaid access numbers 126 and database of customer information 125. Database administrator 129 communicates with databases 125, 126 to maintain database integrity. Remote monitoring 128 monitors one or more kiosk 10 and may selectively activate various features such as the biometric recording devices 26 at additional intervals. Remote monitoring 128 also allows for selective shutdown of kiosk 10 as well as diagnosis and trouble shooting of kiosk 10.

A reporting system 127 represented by “IP based web interface reporting system” 127 allows for access to the customer information database 125 and transactional data stored in the customer information database 125. The reporting system is connected to a “SOAP/XML interface to billing system” 130 to provide billing information for the telecommunication provider and a “transactional history and audit reporting” 131 to provide audit reports and transactional histories on an automated basis or by query to the reporting system 127. Reporting system 127 is preferably web based to provide a graphical user interface and conventional query tools based on the database structure.

Referring now to FIG. 4 of the drawings, an example of a graphical user interface for use on a touchscreen 14 is shown, in English. The menu driven interface has four choices, three continuing to provide service and one returning to the start screen 100. Touchscreen 14 allows the user to simply touch icons 32 to choose one of the listed choices.

Referring now to FIGS. 5, 6, and 8 of the drawings, each is a more detailed portion of the flow chart of FIG. 2. FIG. 5 illustrates an Inmate Prepaid Account transaction, while FIG. 6 illustrates a Direct Bill transaction, and FIG. 8 illustrates a Friends and Family transaction. A comparison of the three figures shows that the transaction structure is similar and applicable to many different transaction types.

Referring now to FIG. 7 of the drawings, a schematic of a correctional facility 34 illustrates the possible locations for a kiosk 10. Because it is expected that many transactions will be conducted by individuals other than the inmate, such as friends or family, a kiosk 10 may be located in the public visiting 36 area to allow friends or family to set-up an account or make a payment during a visit to the correctional facility 34. As discussed above, inmates will likely want to set-up an account upon booking, especially for short stay inmates, and therefore a kiosk 10 may be located in a receiving room 38 for inmate access upon receipt into the correctional facility 34 and at other times as dictated by the staff. Where multiple kiosks 10 are being used in a single facility, the kiosks 10 may be directly joined by a wired or wireless network to provide redundant services and backup.

Referring now to FIG. 9 of the drawings, a screen shot of the graphical user interface of a kiosk 10 is shown with a display area 40 having selection icons 32 and a touchscreen keyboard 42 (not shown). The touchscreen keyboard 42 provides customer input without having the added complexity of additional hardware, and thereby reduces maintenance costs for the kiosk 10.

Referring now to FIG. 10 of the drawings, a system 50 is shown for processing transactions from a kiosk 10. System 50 comprises kiosk 10 and a data connection between kiosk 10 and a network 52, such as the Internet or a similar robust communications network. A gateway 54 communicates with the network 52 for approval of credit card or debit card transactions at the kiosk 10, such as authorize.net or another account verification gateway. A customer reporting engine 56 communicates with the network 52 to allow for customized reports telecommunication service providers. A kiosk central server 58 communicates with the network 52 to collect and store all transaction data from the kiosk 10, provide reporting data to the customer reporting engine 56, and store authorization data from the gateway 54 in conjunction with transaction data captured from kiosk 10. Transaction data will include financial information, personal information and biometric measurements collected from kiosk 10. In the embodiment shown, kiosk central server 58 comprises a web server 60, a web service 62, and a database 64. Web server 60 and web service 62 provide a secure and robust connection between database 64 and network 52.

Referring now to FIG. 11 of the drawings, the transmission of transactional data, referred to individually as standard transaction records or STRs, are provided to a telecommunications provider, or partner, via push over an accessible network, such as the World Wide Web or Internet, to the partner. Because of security concerns inherent in any network, the data will typically be received outside of the partner firewall, in what is commonly referred to as a “demilitarized zone” or DMZ. This allows the partner to receive the data and ensure that no harm will be done to the partner network by allowing the data inside the network firewall. Once the data is within the firewall, it may be processed into the partner billing system. FIG. 11 illustrates one of many secure means for transferring transaction data to partners. While the system shown has been developed to meet current partner demands, variations to this system are easily applied to the current system to meet future partner demands. Furthermore, the partner may provide a wide variety of services including telecommunications or commissary services.

Referring now to FIG. 12 of the drawings, a graphical user interface for the customer reporting engine 56 is shown with sample transaction data. Transaction data includes the following fields:
Transaction Unique Identifier;
Kiosk Identity;
Kiosk Location (often includes multiple fields such as street address, city, state, zip code, room number, room description, location in facility, or kiosk number in facility);
Time and date code;
Amount of transaction;
Type of transaction;
Form of payment;
Authorization information (often includes multiple fields such as success, positive or negative, and confirmation code); and
Biometric data (may include photo, face scan, fingerprint scan, voice recording, voice scan, iris scan, or other biometric data used to distinguish and individual from the general population).

The fields are provided in a web based application that allows queries based on the fields to provide customized reports. Such reports can help to provide more efficient customer service, fraud prevention, system audits, and troubleshooting.

It is apparent that an invention with significant advantages has been described and illustrated. Although the present invention is shown in a limited number of forms, it is not limited to just these forms, but is amenable to various changes and modifications without departing from the spirit thereof.

1. A kiosk comprising:
an input/output device adapted to provide ease of data entry;
a payment reader; and
a processor adapted to communicate transaction information to a network for setting up and managing telecommunications service accounts, wherein the processor is adapted to activate a telecommunications service account substantially contemporaneous with the verification of a payment accepted by the payment reader.

2. The kiosk of claim 1 wherein the processor directs the storing of data relating to a transaction for storage in a single database on the network.

3. The kiosk of claim 1 wherein the input/output device is a touchscreen.

4. The kiosk of claim 1 wherein the payment reader is a cash bill validator.

5. The kiosk of claim 1 wherein the payment reader is a magnetic card reader.

6. A kiosk comprising:
an input/output device adapted to provide ease of data entry;
a payment reader;
a biometric measurement device adapted to record biometric measurements during a transaction; and
a processor adapted to communicate transaction information to a network for setting up and managing telecommunications service accounts.

7. The kiosk of claim 6 wherein the processor directs the storing of data relating to a transaction and biometric data for storage in a single database on the network.

8. The kiosk of claim 6 wherein the biometric data is a photograph.

9. The kiosk of claim 6 wherein the biometric data is a voice recording.

10. The kiosk of claim 6 wherein the input/output device is a touchscreen.

11. The kiosk of claim 6 wherein the payment reader is a cash bill validator.

12. The kiosk of claim 6 wherein the payment reader is a magnetic card reader.

13. A system for providing telecommunication service account set-up and payment, the system comprising:
a kiosk for customer data input;
a database for storing customer data;
a gateway service for providing automated authorization of payment methods;
a telecommunication service provider providing automated account set-up; and
a network allowing communication between the kiosk, the database, the gateway service, and the telecommunications service.

14. The system of claim 13 wherein the kiosk comprises:
an input/output device adapted to provide ease of data entry;
a payment reader; and
a processor adapted to communicate transaction information to the network for setting up and managing telecommunications service accounts, wherein the processor activates a telecommunications service account substantially contemporaneous with the verification of a payment accepted by the payment reader.

15. The system of claim 14 wherein the processor directs the storing of data relating to a transaction in a single database on the network.

16. The system of claim 14 wherein the input/output device is a touchscreen.

17. The system of claim 14 wherein the payment reader is a cash bill validator.

18. The system of claim 14 wherein the payment reader is a magnetic card reader.

19. The system of claim 13 further comprising a customer reporting engine adapted to query the database for transaction records.

20. The system of claim 13 further comprising remote monitoring of the kiosk via the network.

21. The system of claim 13 wherein the processor is adapted to provide a user of the kiosk a choice of at least two languages by which the transaction is conducted.

22. A system for providing telecommunication service account set-up and payment, the system comprising:
a kiosk for customer data input and concurrent biometric measurement during a transaction;
a database for storing customer data and biometric measurement;
a gateway service for providing automated authorization of payment methods;
a telecommunication service provider providing automated account set-up; and
a network allowing communication between the kiosk, the database, the gateway service, and the telecommunications service.

23. The system of claim 22 wherein the kiosk comprises:
an input/output device adapted to provide ease of data entry;
a payment reader;
a biometric measurement device adapted to record biometric measurements during a transaction; and
a processor adapted to communicate transaction information to a network for setting up and managing telecommunications service accounts.

24. The system of claim 23 wherein the processor directs the storing of data relating to a transaction and biometric data for storage in a single database on the network.

25. The system of claim 23 wherein the biometric data is a photograph.

26. The system of claim 23 wherein the biometric data is a voice recording.

27. The system of claim 23 wherein the input/output device is a touchscreen.

28. The system of claim 23 wherein the payment reader is a cash bill validator.

29. The system of claim 23 wherein the payment reader is a magnetic card reader.

30. The system of claim 22 further comprising a customer reporting engine adapted to query the database for transaction records.

31. The system of claim 22 further comprising remote monitoring of the kiosk via the network.

32. The system of claim 22 further comprising a prepaid access number database to provide unique access numbers to prepaid customers.

33. The system of claim 22 further comprising a menu driven interface at the kiosk to provide efficient data entry and service selection in multiple languages.

34. A method of providing telecommunications service account set-up, the method comprising the steps of:
providing a kiosk adapted to collect data and communicate the data to a network;
querying a customer via the kiosk for customer data necessary to set-up an account;
accepting and verifying payment at the kiosk for the account;
storing the customer data and payment verification on a database in communication with the network; and
providing account activation substantially contemporaneous with the acceptance and verification of the payment.

35. The method of claim 34 additionally including the step of providing the customer a choice of at least two languages by which the transaction is conducted.

36. A method of providing telecommunications service account set-up, the method comprising the steps of:
providing a kiosk adapted to collect data and communicate the data to a network;
querying a customer via the kiosk for customer data necessary to set-up an account;
accepting and verifying payment at the kiosk for the account;
taking biometric measurements of the customer during a transaction to confirm the identification of the customer at a later time;
storing the customer data, payment verification, and biometric measurement on a database in communication with the network; and
automating the approval of an account setup once all necessary data is stored in the database.

37. The method of claim 36 additionally including the step of providing the customer a choice of at least two languages by which the transaction is conducted.
